(19) United States
(12) Patent Application Publication
(10) Pub. No.: US 2013/0279724 A1
(43) Pub. Date: Oct. 24, 2013

(54) AUTO DETECTION OF HEADPHONE ORIENTATION

(71) Applicants: Jeffrey Roger Stafford, Redwood City, CA (US); Noam Rimon, Redwood City, CA (US); Jeppe Oland, San Francisco, CA (US)

(72) Inventors: Jeffrey Roger Stafford, Redwood City, CA (US); Noam Rimon, Redwood City, CA (US); Jeppe Oland, San Francisco, CA (US)

(73) Assignee: Sony Computer Entertainment Inc., Foster City, CA (US)

(21) Appl. No.: 13/451,451

(22) Filed: Apr. 19, 2012

(51) Int. Cl. H04R 5/02; H04R 1/10

(52) U.S. Cl. 381/309; 381/74

(57) ABSTRACT

A detector located on or near an ear piece may automatically detect whether a left or right ear or neither ear is wearing the ear piece. A signal mixer may automatically apply a correct configuration to signals transmitted to or from the ear piece according to whether the left or right ear or neither ear is determined to be wearing the ear piece. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The present invention is directed to audio systems that use earpieces to provide sound to a user and more specifically to methods and apparatus for providing sound to such earpieces.

### BACKGROUND OF THE INVENTION

Modern headphones and ear buds are explicitly designed to be worn in the correct orientation, with one ear pad/ear bud labeled for the left ear and one labeled for the right ear. If a user does not look at the labeling on the headphones/ear buds, which many times are minute and/or unclear, they can potentially wear them incorrectly with the stereo channels reversed. This problem is more likely for wireless headphones/ear buds and headphones where the ear cup or ear bud is symmetric and it is difficult to tell which ear cup or ear bud is for which ear. This problem seriously manifests itself in cases of surround sound (like in movies) where the characters or effects will now be reversed in audio vs. what's on screen.

It is within this context that embodiments of the present invention arise.

### BRIEF DESCRIPTION OF THE DRAWINGS

FIG. 1 is a schematic diagram depicting a set of over-the-ear headphones with sensors in the ear-cups according to an embodiment of the present invention.

FIGS. 2A-2C are flow diagrams illustrating examples of methods for providing sound to an ear piece according to an embodiment of the present invention.

FIG. 3A is a block diagram illustrating a computer apparatus that may be used to implement a method for providing sound to an ear piece according to an embodiment of the present invention.

FIG. 3B is a block diagram illustrating a circuit configured to switch the polarity of the signals applied to left and right ear pieces.

FIG. 4 is a diagram depicting a left ear as seen from an ear cup when a set of headphones are placed correctly and proximity sensors detect a characteristic structure of the left ear.

FIG. 5 is a diagram depicting a right ear as seen from an ear cup when a set of headphones are positioned with the left ear cup to the right ear.

FIG. 6 is a schematic diagram illustrating an ear piece in the form of an ear bud having proximity sensors placed around the ear bud in accordance with an embodiment of the present invention.

FIGS. 7A-7B are schematic diagrams illustrating determination of ear placement using proximity in relation to ear buds.

FIG. 8 is a diagram illustrating operation of an embodiment of the invention in a case where a DJ-Style Headphone which has both Left and Right channels mixed into one ear piece.

### DESCRIPTION OF THE SPECIFIC EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

People who use audio headsets receive excellent quality sound but are often unaware of sounds coming from behind them. Some have proposed a “digital horn” that a cyclist can use to broadcast “cyclist on your left” to the left earphone of a person wearing a headset. Of course, operation of such a system assumes that the earphones are being worn correctly. However, for some types of headsets, such as ear buds, there is an approximately equal chance that a user could wear the headset with the earphones in the wrong orientation if the user does not check the labeling.

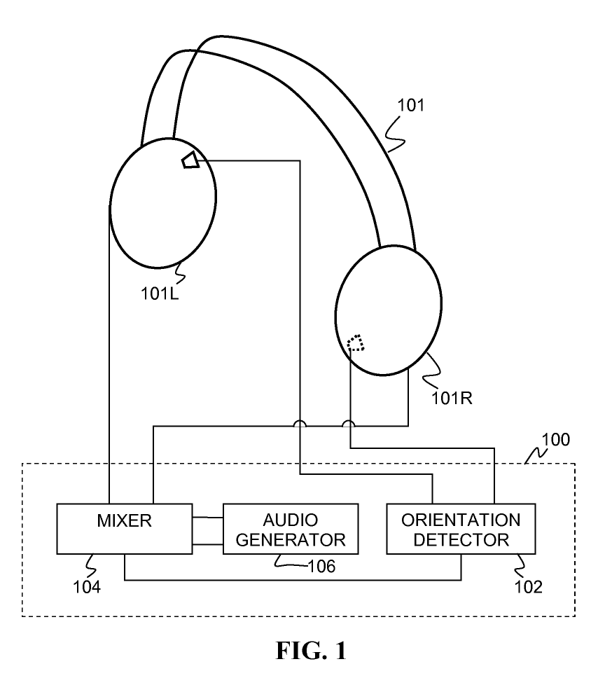

According to embodiments of the present invention, a solution to this problem is to automatically detect which ear piece is on which ear and then switch the audio input to the ear pieces so that the correct signal (left or right) goes to the correct ear piece. FIG. 1 illustrates the concept schematically. As seen in FIG. 1, an apparatus 100 for providing sound to an ear piece may include a detector 102 that is configured to automatically detect whether a left or right ear is wearing the ear piece. In this example, an audio headset 101 may include left and right earpieces in the form a left earphone 101L and a right earphone 101R. The detector 102 may be respond to signals from sensors located on or near each earphone. Such sensors may be configured for the specific purpose of detecting headphone orientation. Alternatively, features of an existing headphone may be adapted to provide signals that can be analyzed by the detector 102 to determine headphone orientation.

The detector 102 may be implemented in hardware, e.g., as an application specific integrated circuit (ASIC) or in software running on a suitably programmed processor. The earpiece orientation detector 102 is coupled to a signal mixer 104, which receives audio input signals for one or more earpieces from an audio generator 106. By way of example, the audio generator may supply a left audio input L for the left earphone 101L and a right audio input R for the right earphone 101R. The signal mixer 104 is configured to automatically apply a correct configuration to signals transmitted to or from the ear piece(s) according to whether the orientation detector 102 determines that a left or right ear is wearing an ear piece. For example, if the orientation detector 102 determines that the earphones 101L and 101R are being worn correctly (e.g., the left earphone 101L is worn on a user's left ear and the right earphone 101R is being worn on the user's right ear) the signal mixer applies the left audio input L to the left earphone 101L and the right audio input R to the right earphone 101R. If the orientation detector 102 determines that the earphones 101L and 101R are being worn incorrectly (e.g., the left earphone 101L is worn on a user's right ear and the right earphone 101R is being worn on the user's left ear) the signal mixer applies the left audio input L to the right earphone 101R and the right audio input R to the left earphone 101L.

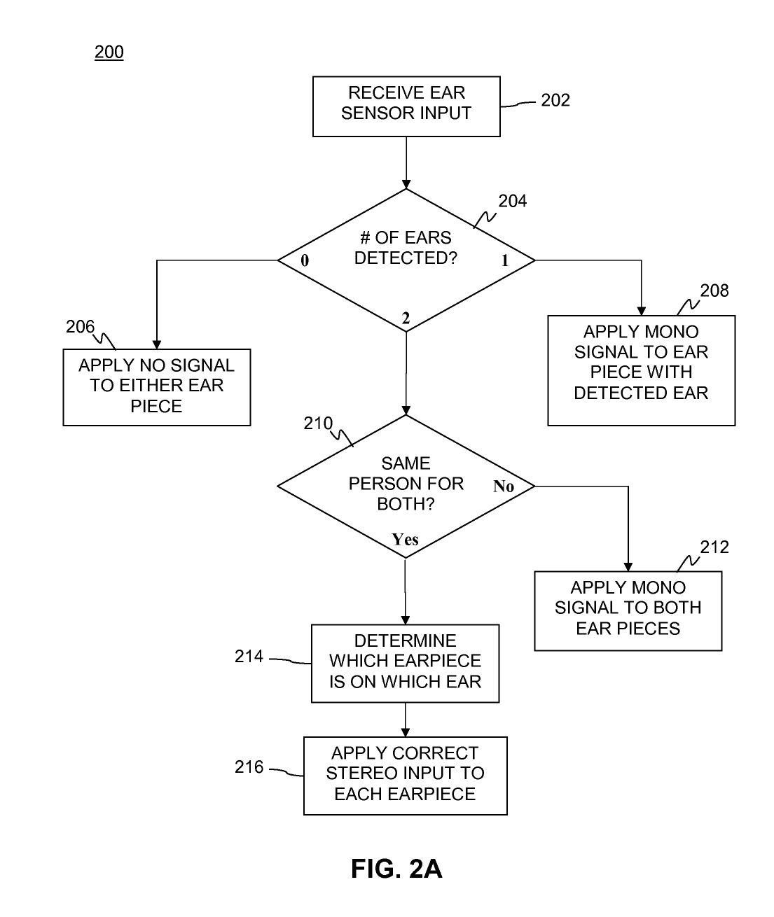

There are a number of different ways in which the mixer 104 may operate to provide the correct audio input depending on whether one earpiece is being worn correctly, both are being worn correctly, or none are being worn correctly. The flow diagram depicted in FIG. 2A illustrates one possible method 200 by which the mixer 104 may address a number of common situations.

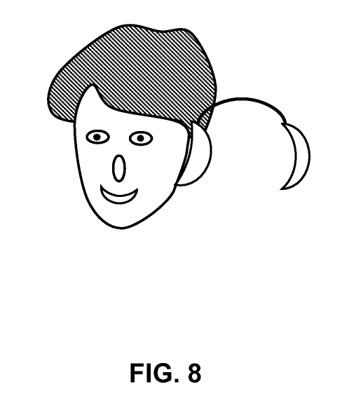

Starting at 202 the mixer may receive an input from the detector 102 indicating a number of ears on which earpieces are being worn. For example, if the earpieces are the two earphones 101L and 101R on the headset 101, there are three possibilities; earphones could be worn on two ears, on one ear, or none. If, at 204 it is determined that none of the earpieces is being worn, the mixer 104 may apply no audio signal to either earpiece, as indicated at 206. If at 204 it is determined that one earpiece is being worn, then the mixer 104 may mix the left audio input L and the right audio input R down to a mono signal and apply the resulting downmixed mono signal to the detected earpiece, as indicated at 208. An example of a situation in which this might be done is shown in FIG. 8. Another example would be where only one earpiece is used, e.g., while driving, in order to comply with the law.

In some embodiments, the sensors could be used to detect when two different people are listening on different earpieces of the same headset as indicated at 210. For example a first user could be listening with one earphone in the first user's left ear and a second user could be listening with the other earphone in the second user's right ear. The detector 102 may be configured to detect this situation, e.g., by measuring electrical resistance, electrical impedance, or acoustic conductance between the two earphones 101R, 101L. The detector 102 could then send mono to both ear phones. Alternatively, completely different audio signals, e.g., different musical tracks may be supplied to the two earphones 101L, 101R in response to a determination that the two different ear pieces of the pair of ear pieces are worn by ears belonging to two different listeners.

If it is determined at 210 that the same person is wearing both earphones 101R, 101L, then the orientation detector 102 may determine which earpiece is on which ear, as indicated at 214 and the correct stereo input may then be applied to each earpiece, as indicated at 216.

It is noted that there are different configurations for the apparatus 100. For example, the apparatus 100 may implemented as a self-contained mechanism within the headset 101. For example, the headset 101 may include orientation sensors and electronic components configured to implement the functions of the orientation detector 102 and the mixer 104. In some implementations, the headset 101 may also include components that implement the functions of the audio generator 106. Alternatively, the functions of some or all of the orientation detector 102, mixer 104, and audio generator 106 may be implemented in a separate device, e.g., an audio player that is used in conjunction with the headset 101.

In an alternative implementation the apparatus 100 may automatically detect whether a left or right ear or neither ear is wearing the ear piece, by prompting a user to wear an ear piece in a designated ear and then detecting whether the ear piece has been placed in or on an ear. An example of such a method 220 is illustrated in FIG. 2B. Specifically, the apparatus 100 may prompt a user to wear the headset by putting an ear piece (either ear piece in the headset 101) in a designated ear first, as indicated at 222. For example, the prompt may be in the form of a written or graphical instruction indicating that the user should put on a pair of ear buds by placing one in the left ear first. The prompt may appear on a visual display that is used in conjunction with the apparatus 100 or may be written on packaging for the apparatus 100 or headset 101. The orientation detector 102 may then simply determine which ear piece is installed first, as indicated at 232 and an appropriate audio mix may be applied to the headset 101 assuming that the first-installed ear piece is on the designated ear, as indicated at 234. As indicated at 228 the apparatus may determine whether only one or both ear pieces are being worn. If only one piece is being worn, a downmixed mono signal may be applied to the worn earpiece, as indicated at 230. If both ear pieces are being worn, as indicated at 234, a stereo or surround sound audio mix, may be applied with the configuration of the signals determined based on the assumption that the first-installed earpiece is worn on the correct ear.

There are a number of ways that the orientation detector 102 may determine whether an ear piece is being worn. Some ways involving sensors on the ear piece are discussed below. Other ways, which are also discussed below, involve using a standard transducer (e.g., an audio speaker) on the ear piece as a microphone. The orientation sensor 102 can detect signals, or changes in signals, that are produced by the transducer when it is worn on an ear compared to when it is not. In such a case, the apparatus 100 and orientation detector 102 may be implemented without sensors in the headset 101. Another way of looking at this is that the sensor function may be implemented using an existing standard component of the headset 101.

In another variation on the above described methods, the orientation detector 102 may operate in conjunction with a user input device to determine which ear piece is wearing an ear. Specifically, apparatus 100 may automatically detect whether a left or right ear or neither ear is wearing the ear piece by generating a sound to a designated ear piece and receiving an input from a user indicating which of the user's ears hears the sound. FIG. 2C illustrates an example of such a method 240. As indicted at 242 the audio generator may play a sound in a designated ear piece in the headset 101. The orientation detector 102 may then receive an input from a user indicating which of the user's ears hears the tone. The input may be provided in any of a number of ways. By way of example, and not by way of limitation, the user may be presented with an audio or visual prompt asking “which ear hears the sound?” and a choice of buttons to press or graphical user interface inputs to select in order to indicate “left” or “right”. In some versions of this implementation, the user may press a button on the earpiece in which the sound is heard. Alternatively, the user may tap the earpiece in which the sound is heard and the transducer in the earpiece may pick up the sound of the tapping and relay it to the orientation detector 102. In such a case, the apparatus 100 and orientation detector 102 may be implemented without sensors in the headset 101. Another way of looking at this is that the sensor function may be implemented using an existing standard component of the headset 101.

The sound may be played in only one earpiece or in both ear pieces one at a time. This allows the orientation detector to optionally determine whether both earpieces are being worn, as indicated at 246. Based on the user input, the mixer 104 may then apply the appropriate signals to both ear pieces as indicated at 248. For example, if the user input indicates that the sound applied to the designated earpiece is heard in the left ear, the mixer 104 may apply the left audio input to the designated ear piece and the right audio signal to the remaining earpiece (assuming that there are two of them). In some cases, if only one ear piece is worn, a downmixed mono signal may optionally be applied to the designated earpiece, as indicated at 250.

In some implementations, the orientation detector 102 may be configured to take into account the possibility that the user hears no sound in either ear. This may occur, for example, in the case of a malfunction of designated ear piece or of the headset 101. It may also occur if the headset 101 is not properly plugged in or powered on. In such cases, the orientation detector 102 may direct the user through a checklist to help determine the nature of the problem, e.g., by prompting the user to check a power supply to the headset 101 or a connection between the headset 101 and the mixer 104 or audio generator 106.

There are some circumstances under which it may be desirable to determine which ear is wearing an earpiece even if a mono signal is ordinarily applied to the earpiece. For example, a Bluetooth headset worn on a single ear often delivers a mono signal, since the headset can be used with either ear. However, when the headset is switched from one ear to another, the buttons on the headset retain their functions. This may result in some confusion to the user. For example, suppose the user wears the headset in the right ear and there are two buttons on the headset. One button controls the volume and one turns the headset on or off. Suppose further that these buttons are located one above the other such that when the user wears the headset on the right ear the “on/off” button is above the volume control button. If the user switches the headset from the right ear to the left ear, both buttons remain in the same place on the headset but their locations relative to the user are reversed due to a 180 degree rotation of the headset. Thus, when the user wears the headset on the left ear, the volume control button would be above the “on/off” button. The apparent reversal of the buttons can be confusing to some users who may expect the upper button to always function as the on/off button and the lower button to function as the volume control.

In an embodiment of the present invention, a sensor may be configured to detect which ear is wearing the headset and the control buttons may be programmable by processor executable instructions that could swap the control button orientation based on the detected headset orientation. For in the situation described above, the on/off function could be consistently mapped to the upper of the two buttons and the volume control function is consistently mapped to the lower of the two buttons.

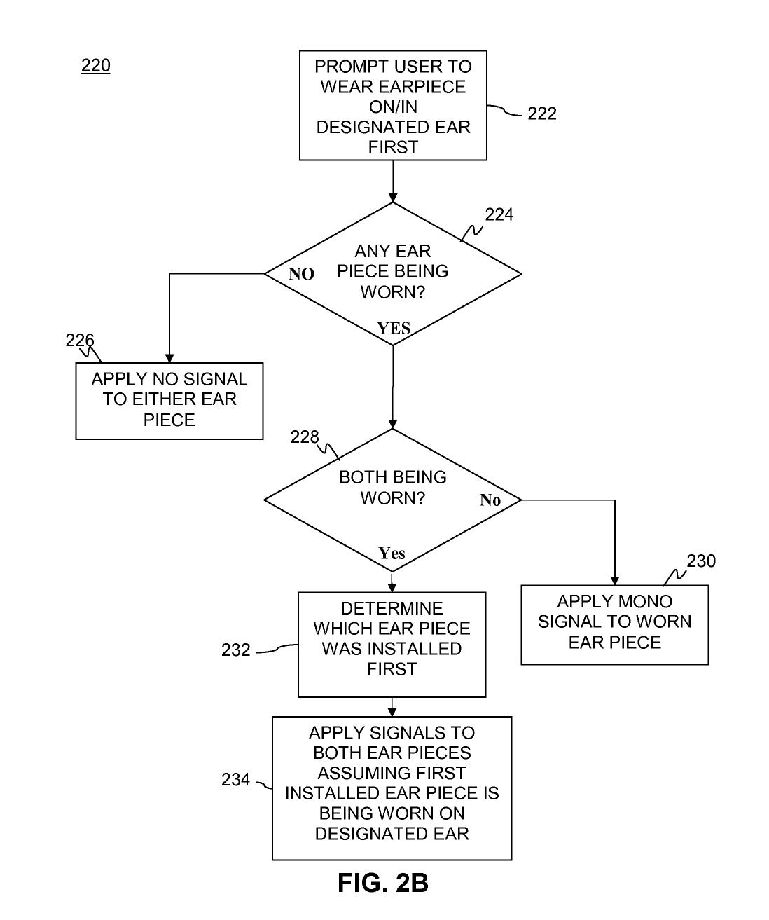

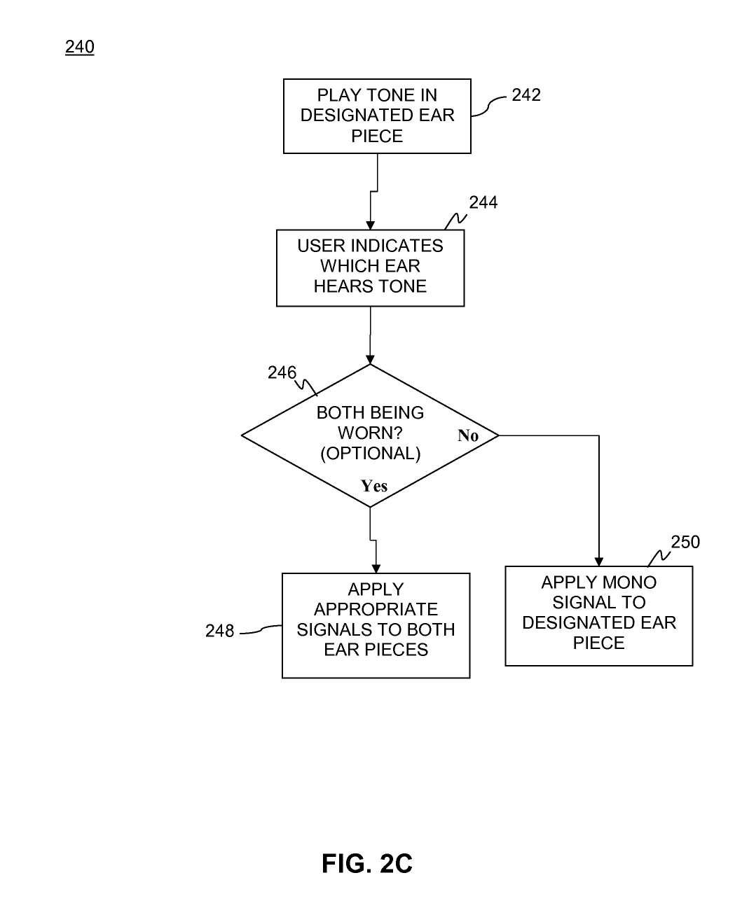

As noted above, embodiments of the present invention may be implemented partly on a device that is used in conjunction with a headset. By way of example, and not by way of limitation, FIG. 3A depicts a block diagram illustrating the components of a device 300 according to an embodiment of the present invention. By way of example, and without loss of generality, the device 300 may be implemented as a computer system, such as a personal computer, video game console, audio player, tablet computer, cellular phone, portable gaming device, or other digital device, suitable for practicing an embodiment of the invention. The device 300 may include a processor unit 301 configured to run software applications and optionally an operating system. The processor unit 301 may include one or more processing cores. By way of example and without limitation, the processor unit 301 may be a parallel processor module that uses one or more main processors, sometimes and (optionally) one or more co-processor elements. In some implementations the co-processor units may include dedicated local storage units configured to store data and or coded instructions. Alternatively, the processor unit 301 may be any single-core or multi-core (e.g., dual core or quad core) processor.

A non-transitory storage medium, such as a memory 302 may be coupled to the processor unit 301. The memory 302 may store program instructions and data for use by the processor unit 301. The memory 302 may be in the form of an integrated circuit, e.g., RAM, DRAM, ROM, and the like). A computer program 303 and data 307 may be stored in the memory 302 in the form of instructions that can be executed on the processor unit 301. The program 303 may include instructions configured to implement, amongst other things, a method for providing sound to an ear piece, e.g., as described above with respect to FIG. 2A, FIG. 2B, and FIG. 2C. Specifically, the device 300 may be configured, e.g., through appropriate instructions in the program 303 to automatically detect whether a left or right ear or neither ear is wearing the ear piece and automatically apply a correct configuration to signals transmitted to or from the ear piece according to whether the left or right ear or neither ear is determined to be wearing the ear piece. It is noted that the ear piece may or may not be part of the device 300. By way of example and not by way of limitation, one or more ear pieces may be implemented in a pair of headphones 319 having first and second earpieces 319A, 319B.

The device 300 may also include well-known support functions 310, such as input/output (I/O) elements 311, power supplies (P/S) 312, a clock (CLK) 313 and cache 314. The I/O elements may include or may be coupled to a switch SW that directs audio input signals to the first and second earpieces 319A, 319B. An example of such a switch is described below with respect to FIG. 3B.

The client device 300 may further include a storage device 315 that provides an additional non-transitory storage medium for processor-executable instructions and data. The storage device 315 may be used for temporary or long-term storage of information.

By way of example, the storage device 315 may be a fixed disk drive, removable disk drive, flash memory device, tape drive, CD-ROM, DVD-ROM, Blu-ray, HD-DVD, UMD, or other storage devices. The storage device 315 may be configured to facilitate quick loading of the information into the memory 302.

One or more user input devices 318 may be used to communicate user inputs from one or more users to the computer device 300. By way of example, one or more of the user input devices 318 may be coupled to the client device 300 via the I/O elements 311. Examples of suitable input devices 318 include keyboards, mice, joysticks, touch pads, touch screens, light pens, still or video cameras, and/or microphones. In addition, the headset 319 may be coupled to the device 300 via the I/O elements 311. The client device 300 may include a network interface 320 to facilitate communication via an electronic communications network 327. The network interface 320 may be configured to implement wired or wireless communication over local area networks and wide area networks such as the Internet. The client device 300 may send and receive data and/or requests for files via one or more message packets 326 over the network 327.

In some embodiments, the device 300 may further comprise a graphics subsystem 330, which may include a graphics processing unit (GPU) 335 and graphics memory 340. The graphics memory 340 may include a display memory (e.g., a frame buffer) used for storing pixel data for each pixel of an output image. The graphics memory 340 may be integrated in the same device as the GPU 335, connected as a separate device with GPU 335, and/or implemented within the memory 302. Pixel data may be provided to the graphics memory 340 directly from the processor unit 301. Alternatively, the processor unit 301 may provide the GPU 335 with data and/or instructions defining the desired output images, from which the GPU 335 may generate the pixel data of one or more output images. The data and/or instructions defining the desired output images may be stored in memory 302 and/or graphics memory 340. In an embodiment, the GPU 335 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 335 may further include one or more programmable execution units capable of executing shader programs.

The graphics subsystem 330 may periodically output pixel data for an image from the graphics memory 340 to be displayed on a video display device 350. The video display device 350 may be any device capable of displaying visual information in response to a signal from the client device 300, including, but not limited to CRT, LCD, plasma, and OLED displays. The computer client device 300 may provide the display device 350 with an analog or digital signal. By way of example, the display 350 may include a cathode ray tube (CRT) or flat panel screen that displays text, numerals, graphical symbols or images.

To facilitate generation of sounds to be provided to the earpiece (e.g., headset 319), the client device 300 may further include an audio processor 355 adapted to generate analog or digital audio output from instructions and/or data provided by the processor unit 301, memory 302, and/or storage 315. The audio processor may generate signals, e.g., digital or analog electronic signals that correspond to sounds for one or more speakers in an earpiece. The signals may correspond to mono, stereo, or other audio configurations depending on the type of earpiece or earpieces used in conjunction with the device 300. These signals can then be selectively routed to one or more earpieces, e.g., to the left and right headphones in the headset 319 depending on the detected orientation of the headset with respect to a user's ears. In some embodiments, the method of providing sound to an earpiece may be implemented in hardware or firmware that is part of the audio processor 355.

The components of the device 300, including the CPU 301, memory 302, support functions 310, data storage 315, user input devices 318, network interface 320, audio processor 355, and an optional geo-location device 356 may be operably connected to each other via one or more data buses 360. These components may be implemented in hardware, software or firmware or some combination of two or more of these.

As noted above, audio input signals for first and second earpieces 319A, 319B may be routed using a switch SW. The switch may be implemented as a mechanical device, such as a relay or in the form of a solid state electronic switch. It is noted that embodiments of the present invention also include implementations in which the functions of the switch SW may be implemented by the client device 300 as a pure software function. By way of example, FIG. 3B illustrates a possible implementation of a switch SW in conjunction with TRS (Tip, Rind and Sleeve) connectors 371, 373 to switch Left/Right headphone polarity in response to determination of the orientation of the headphones 319A, 319B in the headset 319. The headset 319 may be connected to the device 300 through the switch SW via a cable 372 with TRS connectors 371, 373 at each end. The TRS connectors may be configured to couple power signals and audio input signals to the left and right earphones 319A, 319B. The switch SW may selectively route the left and right audio input signals to the earphones 319A, 319B in response to a signal from the device 300 that indicates the orientation of the headphones. Specifically, when the left headphone 319A is determined to be on a user's left ear and the right headphone 319B is determined to be on the same user's right ear the switch SW would route the left audio input signal to the left earphone 319A and the right audio input signal to the right earphone 319B. If it is determined that the orientation of the earphones is reversed from normal (i.e., the right headphone is on the left ear and vice versa), the device 300 sends a signal to the switch to reverse the routing of the audio input signals, e.g., as shown in FIG. 3B, so that the right audio input signal is routed to the left earphone 319A and the left audio input signal is routed to the right earphone 319B.

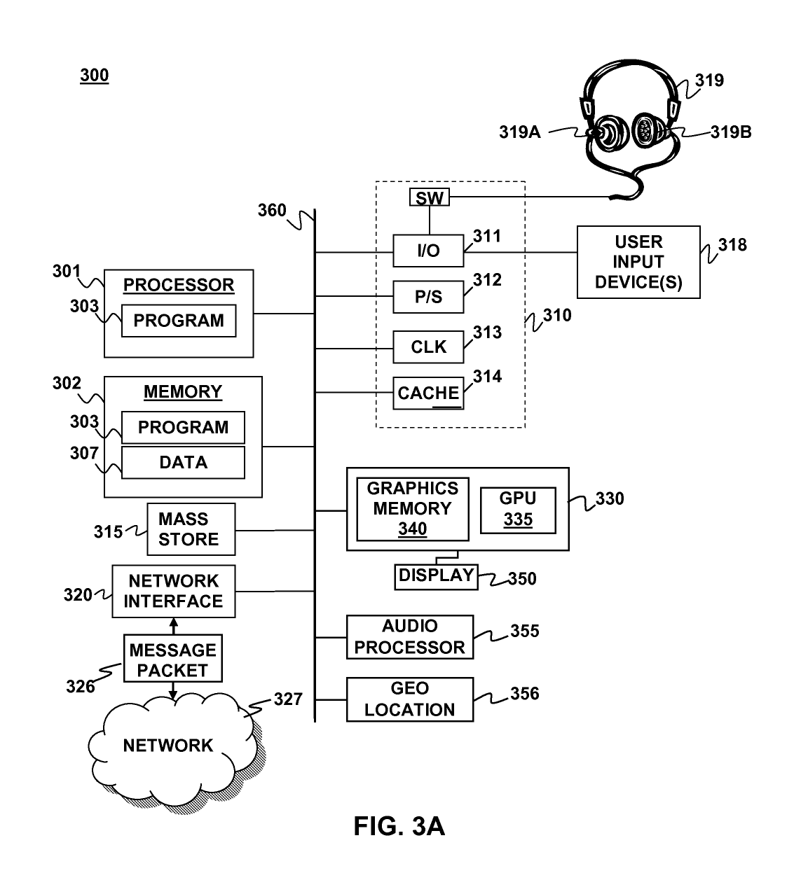

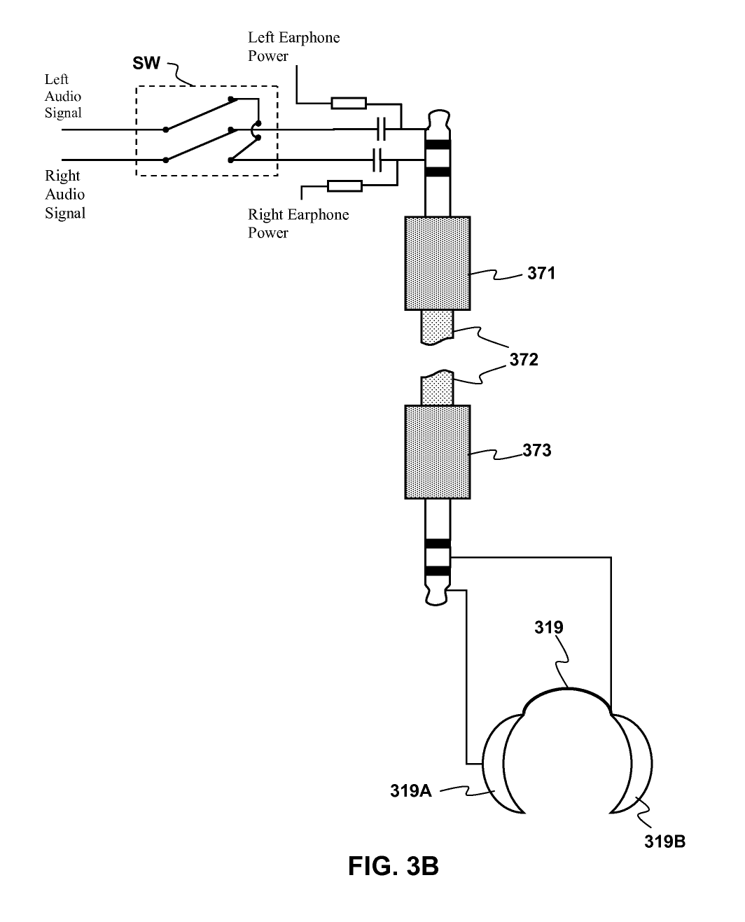

There are a number of ways in which earpiece orientation may be determined. By way of example, as shown in FIG. 4, sensors 402 may be situated on an earpiece 404 in known positions relative to the earpiece such that the sensors 402 are located proximate to a characteristic structure of the ear 406 when the earpiece is worn correctly, e.g., in the proper orientation on the correct ear. The sensors 402 may be located on the earpiece such that if the earpiece is worn on the wrong ear, as in FIG. 5, the sensors 402 either do not detect the characteristic structure of the ear 406 or otherwise produce a signal indicating that the characteristic structure of the ear is in the wrong place relative to the sensors.

By way of example, and not by way of limitation, the characteristic structure of the ear 406 that is detected by the sensors 402 may be located on the external part of the ear, known as the pinna. Examples of suitable structures on the pinna include the helix H, the anti-helix AH, scapha S, the fossa triangularis FT, the tragus T, the anti-tragus AT, and the ear lobe L. Other characteristic structures on the ear include the concha C.

The sensors 402 may be built into headsets or may be added on to existing headsets, e.g., as a clip-on device. The sensors may provide signals to a local processor that is either included with the sensor or built into the headset or individual earpiece. Alternatively, the sensors may be coupled to a processor on a remote device like device 300, e.g., by wired or wireless connection.

For over the ear headphones, the proximity sensors 402 may be positioned on one side of the ear cups, matching the one-sided position of the ear's auricular helix as shown in FIG. 4. If the proximity sensors 402 register a signal indicting that the helix is very close (e.g., the signal is within a predetermined threshold), then it may be reasonably determined that the headphones are placed in their standard correct stereo orientation (left cup to left ear, right cup to right ear).

The sensors 402 could be configured to detect the auricular helix 406 based on detection of physical contact with the auricular helix. Alternatively, the sensors may operate based on acoustic, electromagnetic, or optical principles. By way of example, and not by way of limitation, the sensors may be proximity sensors based on capacitance. In such a case, the method 200 or the device 300 may be calibrated to distinguish between capacitance signals generated by the sensors 402 when the earpiece 404 is worn correctly and when it is not.

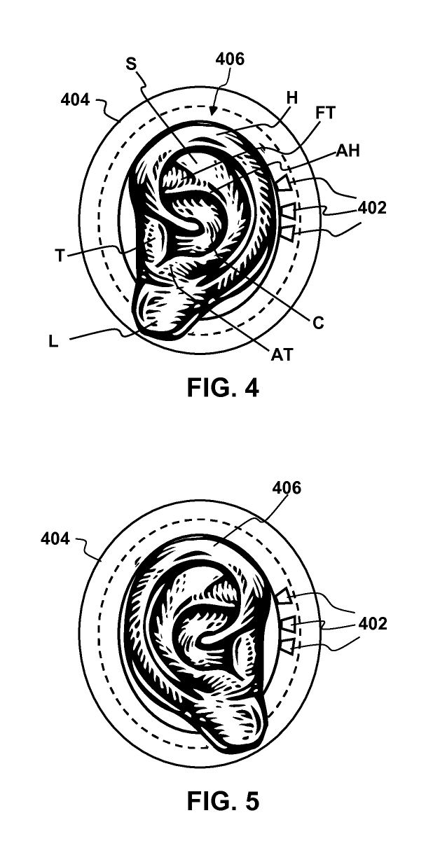

Embodiments of the invention are not limited to implementations that use over-the-ear headphones. FIG. 6 is a schematic diagram illustrating an ear piece in the form of an ear bud 604 having proximity sensors 602 placed at different angles around the ear bud for detecting the location of a characteristic structure of the ear. By way of example, the sensors 602 may be placed behind holes 603 used for air flow in the ear bud 604. The sensors may be any of the types described herein. It should be noted that proximity sensors based on capacitance are just one example of methods for determining ear placement, other methods also exist. For example, the sensors 602 may include light sensing diodes to detect difference in light between one side of an earbud and another. Such sensors may be configured such that more light falls on the diodes that are on the side of the ear bud that is not next to the ear.

The sensors may be placed on a side of the ear bud 604 that is closest to the characteristic structure when the ear bud is worn in the correct ear. For example, in the ear bud shown in FIG. 6, the sensors are located such that they would be closest to the auricular helix when the illustrated ear bud is worn on the left ear. A wire 607 that connects the ear bud 604 to a device (not shown) may provide a convenient directional reference since many users wear such ear buds with the wires dangling downwards. However, ear buds may be worn at an arbitrary rotation around a horizontal axis X. This is particularly true for wireless ear buds. To facilitate determination of the orientation of the earbud, the ear bud 604 may include an inertial sensor 608, such as an accelerometer to detect the direction of gravity for use as a reference vector in determining the relative location of a characteristic structure of the ear, such as the auricular helix or other structure.

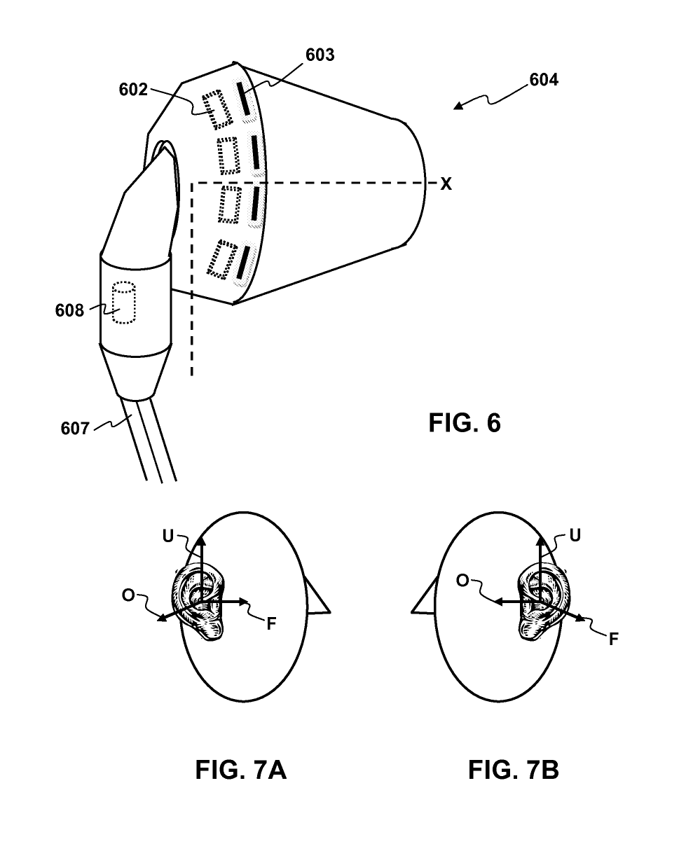

It is noted that detecting the orientation of an ear piece relative to the direction of gravity is useful if the head of the user wearing the ear piece is in an upright orientation. However, the orientation with respect to gravity may provide misleading information in if the user is lying down. Embodiments of the invention may take into account an arbitrary orientation of the user's head by determining a frame of reference for an earpiece relative to a user's head. The frame of reference may be defined by an outward vector O, an upward vector U, and a forward vector F as illustrated in FIG. 7A and FIG. 7B. The outward vector O is directed from the ear outward from the user's head more or less perpendicular to the ear. The forward vector F is directed from the ear toward the front of the user, e.g., towards the user's nose. The upward vector U is directed more or less toward the top of the user's head.

The outward vector O may be easily determined for most ear pieces since one side of the ear piece is normally worn facing the user's ear. The outward vector O may be pre-defined relative to the ear piece as the direction facing away from the user's ear when worn properly. The method 200 or device 300 may use sensors to determine if the earpiece is being worn on or in an ear. In some embodiments this may be done by sending a signal to a speaker built into the earpiece and using the same speaker (or a different speaker in the same earpiece) as a microphone to detect a reverberation signal. In some embodiments, the earpiece may include a separate microphone, which may be adapted for this purpose. The advantage of using the speaker in the earpiece as a microphone is that the earpiece orientation detection may be implemented with an unmodified earpiece. The method or system may determine if the earpiece is worn on or in an ear, e.g., by comparing the characteristics of the reverberation to calibration characteristics determined when the earpiece is worn on or in an ear.

The forward direction F may be determined, e.g., if the ear piece includes sensors to detect the auricular helix or if the ear piece includes two or more acoustic transducers, e.g., two microphones, a microphone and speaker that can be adapted to operate as a microphone or two speakers that can be adapted to operate as microphones. If two transducers are in different known locations with respect to the earpiece it may be possible to determine which of the transducers is closer to a reference in the user's body by analyzing acoustic signals that they detect. For example, the transducers may both detect sounds of the user's breathing. By analyzing differences in the sounds detected a device or method could determine which transducer is closer to the user's mouth or nose. This information could be used to define the forward direction F as being in the general direction of the user's mouth or nose.

In a similar manner, two or more transducers in the ear piece may detect sounds of the user's heartbeat. By analyzing differences in the heartbeat sounds detected by the different transducers a device or method could determine which transducer is closer to the user's heart. This information could be used to define the upward direction U as being in the general direction away from the user's heart.

Once the relative directions of the vectors O, F, and U are determined with respect to the ear piece it is possible to determine whether the ear piece is on a user's left or right ear by determining what is referred to herein as a “parity” of the frame of reference. The parity may be either left handed or right handed and may be determined as follows. A dot product between the forward vector F and cross-product between the outward vector O and the upward vector U (i.e., F·(O×U)) should be positive for right-handed parity and negative for left-handed parity. If the parity is right-handed, the earpiece is worn on the left ear, e.g., as shown in FIG. 7A. If the parity is left-handed, the earpiece is worn on the right ear, e.g., as shown in FIG. 7B.

In an alternative implementation, signals from the transducer or transducers in the ear pieces may be analyzed to detect a difference in audio corresponding to a heartbeat. The detected differences may be compared to reference data obtained under circumstances when it is known which ear is wearing which ear piece. The results of the comparison may be used directly determine which ear is wearing which ear piece.

There are a number of possible variations on the embodiments discussed herein. For example, in some embodiments involving ear buds, it may be useful to determine whether one ear bud or both ear buds are worn by the same user. For example, some devices such as smart phones are configured to act as video/audio players and cellular phones. Such a device could be configured to make a call or accept an incoming call when a user pulls out or inserts one ear bud.

In other embodiments, sensors or reverberation could also be used to detect the presence and absence of earpieces on or in a user's ears and adjust the power or volume of an earpiece accordingly. For example upon detection that an ear piece has been placed on or in or removed from an ear, a device may trigger the earpiece to enter or exit a low power mode, send a signal to a compatible device to enter/exit a low power mode, pause the sound source or reduce the volume. This method is especially efficient for saving battery life on a powered headset.

In some embodiments, a sound may be played on one ear piece and the user may indicate, e.g., through a multi-function button on the earpiece whether the sound is at the left or right ear. This will also protect against the possibility of reversed-pole plugs that have the wrong markings on them. For earbuds, another embodiment may require the user to always place an earbud into the left ear first, thus only requiring the earbud to detect the presence of the ear and not have to determine orientation within the ear.

Embodiments of the present allow for enjoyment of audio devices that can produce high quality sound while greatly simplifying the user's experience with the device.

While the above is a complete description of the preferred embodiments of the present invention, it is possible to use various alternatives, modifications, and equivalents.

Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC §112, ¶6.

What is claimed is:

1. A method for providing sound to an ear piece, comprising:
automatically detecting whether a left or right ear or neither ear is wearing the ear piece with a detector located on or near the ear piece; and
automatically applying a correct configuration to signals transmitted to or from the ear piece with a signal mixer according to whether the left or right ear or neither ear is determined to be wearing the ear piece.

2. The method of claim 1, wherein automatically detecting whether a left or right ear or neither ear is wearing the ear piece includes prompting a user to wear an ear piece in or on a designated ear and then detecting whether the ear piece has been placed in or on an ear.

3. The method of claim 1, wherein automatically detecting whether a left or right ear or neither ear is wearing the ear piece includes prompting a user to indicate which ear, if any, is wearing a given ear piece and receiving an input indicting which ear, if any is wearing the earpiece.

4. The method of claim 1, wherein automatically detecting whether a left or right ear or neither ear is wearing the ear piece includes generating a sound to the ear piece and receiving an input from a user indicating which of the user's ears hears the sound.

5. The method of claim 1, wherein automatically detecting whether a left or right ear is wearing the ear piece includes determining a relative location of a characteristic structure of the left or right ear by analyzing a signal from the detector.

6. The method of claim 5, wherein the detector includes a light sensor configured to optically detect the proximity of the characteristic structure.

7. The method of claim 5, wherein the detector includes a touch sensor configured to mechanically detect the proximity of the characteristic structure.

8. The method of claim 5, wherein the detector includes an electromagnetic sensor configured to electromagnetically detect the proximity of the characteristic structure.

9. The method of claim 5, wherein the detector includes a capacitance sensor configured to capacitively detect the proximity of the characteristic structure.

10. The method of claim 5, wherein the detector includes an acoustic sensor configured to acoustically detect the proximity of the characteristic structure.

11. The method of claim 5, wherein the detector includes a sensor configured to determine a direction of the force of gravity and wherein automatically detecting whether a left or right ear is wearing the ear piece includes taking into account a direction of the force of gravity in determining whether the left or right ear is wearing the earpiece.

12. The method of claim 1, wherein the detector includes an acoustic transducer within the earpiece that is configured to act as both a speaker and a microphone, wherein automatically detecting the relative location of a characteristic structure of the ear includes sending an input signal to the transducer, converting the input signal to an acoustic signal with the transducer, detecting an acoustic reverberation of the acoustic signal with the transducer, converting the acoustic reverberation to an output signal with the transducer and automatically analyzing the output signal to determine whether a left or right ear or neither ear is wearing the ear piece.

13. The method of claim 1, wherein automatically detecting whether a left or right ear or neither ear is wearing the ear piece includes using an audio speaker in the ear piece as a microphone to detect a heartbeat signal and comparing the detected heartbeat signal to a reference heartbeat signal.

14. The method of claim 1, wherein the ear piece is one of a pair of ear pieces configured to supply stereo sound or surround sound inputs.

15. The method of claim 14, wherein automatically applying the correct configuration to signals transmitted to or from the ear piece includes applying a left side stereo signal to a first ear piece of the pair in response to a determination that the first ear piece is worn by a left ear of a listener and applying a right side stereo signal to a second ear piece of the pair in response to a determination that the second ear piece is worn by the right ear of the listener.

16. The method of claim 14, wherein applying the correct configuration to signals transmitted to or from the ear piece includes applying a downmixed mono sound signal to the ear piece in response to a determination that two different ear pieces of the pair of ear pieces are in ears belonging to different listeners.

17. The method of claim 14, wherein applying the correct configuration to signals transmitted to or from the ear piece includes applying a downmixed mono sound signal to the ear piece in response to a determination that a ear piece is worn by one ear of the listener but another ear piece of the pair is not worn by a corresponding second ear of the listener.

18. The method of claim 14, wherein automatically detecting whether a left or right ear or neither ear is wearing the ear piece with a detector located on or near the ear piece includes detecting removal or absence of one ear piece of the pair from one ear of the listener.

19. The method of claim 18, wherein automatically applying a correct configuration to signals transmitted to or from the ear piece includes supplying an alternative audio input to another ear piece of the pair that is determined to be in a second ear of the listener.

20. The method of claim 19, wherein the alternative audio input is a telephone audio signal.

21. The method of claim 1, wherein the ear piece is one of a pair of ear pieces in a headset, wherein applying the correct configuration to signals transmitted to or from the ear piece includes applying different audio signals to two different ear pieces of the pair of earpieces in response to a determination that the two different ear pieces of the pair of ear pieces are worn by ears belonging to two different listeners.

22. The method of claim 1, wherein automatically applying a correct configuration to signals transmitted to or from the ear piece includes interpreting signals from control devices on the earpiece according to whether the left or right ear is wearing the ear piece.

23. The method of claim 22, wherein the ear piece includes two or more control devices in fixed locations relative to the ear piece, and wherein interpreting signals from control devices on the earpiece according to whether the left or right ear is wearing the ear piece includes determining an orientation of the two or more control devices relative to the listener and interpreting signals from one or more of the two or more control devices according to the determined orientation.

24. An apparatus for providing sound to an ear piece, comprising:
a detector configured to automatically detect whether a left or right ear is wearing the ear piece; and
a signal mixer configured to automatically apply a correct configuration to signals transmitted to or from the ear piece according to whether the left or right ear is determined to be wearing the ear piece.

25. The apparatus of claim 24, wherein the apparatus is configured to prompt a user to indicate which ear, if any, is wearing a given ear piece and receive an input from a user indicting which ear, if any is wearing the earpiece.

26. The apparatus of claim 24, wherein the apparatus is configured to generate a sound to the ear piece and receive an input from a user indicating which of the user's ears hears the sound and wherein the signal mixer is configured to apply the correct configuration based on the input.

27. The apparatus of claim 24, wherein the detector is configured to produce a signal that can automatically detect whether a left or right ear is wearing the ear piece includes determining a relative location of a characteristic structure of the ear by analyzing a signal from the detector.

28. The apparatus of claim 24, wherein the detector includes a light sensor configured to optically detect the proximity of the characteristic structure.

29. The apparatus of claim 24, wherein the detector includes a touch sensor configured to mechanically detect the proximity of the characteristic structure.

30. The apparatus of claim 24, wherein the detector includes an electromagnetic sensor configured to electromagnetically detect the proximity of the characteristic structure.

31. The apparatus of claim 24, wherein the detector includes a capacitance sensor configured to capacitively detect the proximity of the characteristic structure.

32. The apparatus of claim 24, wherein the detector includes an acoustic sensor configured to acoustically detect the proximity of the characteristic structure.

33. The apparatus of claim 30, wherein the detector includes an audio speaker in the ear piece that is coupled to a processor, wherein the audio speaker is configured to operate as a microphone, wherein the processor is configured to determine whether a left or right ear is wearing the earpiece by detecting a heartbeat signal from a signal from the speaker operating as a microphone and compare the detected heartbeat signal to a reference heartbeat signal.

34. The apparatus of claim 24, wherein the detector includes a sensor configured to determine a direction of the force of gravity and the detector is configured to take the determined direction of the force of gravity into account in determining whether the left or right ear is wearing the earpiece.

35. The apparatus of claim 24, wherein the detector includes an acoustic transducer within the earpiece that is configured to act as both a speaker and a microphone, wherein the detector is configured to automatically detects the relative location of the characteristic structure by sending an input signal to the transducer, converting the input signal to an acoustic signal with the transducer, detecting an acoustic reverberation of the acoustic signal with the transducer, converting the acoustic reverberation to an output signal with the transducer and automatically analyzing the output signal to determine whether a left or right ear or neither ear is wearing the ear piece.

36. The apparatus of claim 24, wherein the ear piece is one of a pair of ear pieces configured to supply stereo sound or surround sound inputs.

37. The apparatus of claim 36, wherein the signal mixer is configured to automatically apply the correct configuration to signals transmitted to or from the ear piece by applying a left side stereo signal to a first ear piece of the pair in response to a determination that the first ear piece is worn by a left ear of a listener and applying a right side stereo signal to a second ear piece of the pair in response to a determination that the second ear piece is worn by a right ear of the listener.

38. The apparatus of claim 36, wherein the signal mixer is configured to automatically apply the correct configuration to signals transmitted to or from the ear piece by applying a downmixed mono sound signal to the ear piece in response to a determination that two different ear pieces of the pair of ear pieces are in ears belonging to different listeners.

39. The apparatus of claim 36, wherein the signal mixer is configured to automatically apply the correct configuration to signals transmitted to or from the ear piece includes applying a downmixed mono sound signal to the ear piece in response to a determination that ear piece is in one ear of the listener but another ear piece of the pair is not in corresponding second ear of the listener.

40. The apparatus of claim 34, wherein the detector is configured to automatically detect removal or absence of one ear piece of the pair from one ear of the listener.

41. The apparatus of claim 40, wherein the signal mixer is configured to automatically apply a correct configuration to signals transmitted to or from the ear piece by supplying an alternative audio input to another ear piece of the pair that is determined to be in a second ear of the listener.

42. The apparatus of claim 41, wherein the alternative audio input is a telephone audio signal.

43. The apparatus of claim 24, wherein the ear piece is one of a pair of ear pieces in a headset, wherein applying the correct configuration to signals transmitted to or from the ear piece includes applying different audio signals to two different ear pieces of the pair of earpieces in response to a determination that the two different ear pieces of the pair of ear pieces are worn by ears belonging to two different listeners.

44. The apparatus of claim 24, wherein the ear piece includes one or more control devices and wherein the signal mixer is configured to apply a correct configuration to signals transmitted to or from the ear piece by interpreting signals from control devices on the earpiece according to whether the left or right ear is wearing the ear piece.

45. The apparatus of claim 44, wherein the ear piece includes two or more control devices in fixed locations relative to the ear piece, and wherein interpreting signals from control devices on the earpiece according to whether the left or right ear is wearing the ear piece includes determining an orientation of the two or more control devices relative to the listener and interpreting signals from one or more of the two or more control devices according to the determined orientation.
